(19) United States
(12) Patent Application Publication
(10) Pub. No.: US 2026/0179588 A1
(43) Pub. Date: Jun. 25, 2026

(54) STAND, STAND ASSEMBLY METHOD AND KEYBOARD INSTRUMENT SET

(71) Applicant: CASIO COMPUTER CO., LTD., Tokyo (JP)

(72) Inventors: Hiroshi IKEMOTO, Tokyo (JP); Naoto IMAMURA, Tokyo (JP); Otoya SAKAI, Tokyo (JP)

(73) Assignee: CASIO COMPUTER CO., LTD., Tokyo (JP)

(21) Appl. No.: 19/417,413

(22) Filed: Dec. 12, 2025

(30) Foreign Application Priority Data
Dec. 20, 2024 (JP) 2024-225028

(51) Int. Cl. G10G 5/00; G10H 1/34

(52) U.S. Cl. CPC G10G 5/005; G10H 1/348; G10H 2220/221; G10H 2220/265

(57) ABSTRACT

A stand including a lateral-bridging member, a leg section which supports at least one side of front and back sides of a keyboard instrument, and a connection member which connects the lateral-bridging member with the leg section, in which the leg section includes a hook-shaped engaging section provided at one end portion, and the connection member includes an engaging target section corresponding to the hook-shaped engaging section.

### CROSS-REFERENCE TO RELATED APPLICATION

This application is based upon and claims the benefit of priority from the prior Japanese Patent Application No. 2024-225028, filed December 20, 2024, the entire contents of which are incorporated herein by reference.

### BACKGROUND

### 1. Technical Field

The present disclosure relates to a keyboard instrument stand, a stand assembly method, and a keyboard instrument set including the stand.

### 2. Description of the Related Art

For example, a keyboard instrument stand is known which has a four-legged structure where connection members are provided on the ends of a lateral-bridging member on which a keyboard instrument is arranged, and a front leg section and a back leg section are provided on each connection member, as described in Japanese Patent Application Laid-Open (Kokai) Publication No. 2023-157063.

### SUMMARY

An embodiment of the present disclosure is a stand comprising: a lateral-bridging member; a leg section which supports at least one side of front and back sides of a keyboard instrument; and a connection member which connects the lateral-bridging member with the leg section, wherein the leg section includes a hook-shaped engaging section provided at one end portion, and wherein the connection member includes an engaging target section corresponding to the hook-shaped engaging section.

Another embodiment of the present disclosure is a stand assembly method comprising: assembling a pedal frame; attaching connection members attached to sides of a lateral-bridging member to the assembled pedal frame with the pedal frame being laid down; and attaching leg sections to the connection members attached to the pedal frame which has been laid down

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a perspective view showing an embodiment where the present disclosure has been applied in a keyboard instrument set;

FIG. 2 is a front view of the keyboard instrument set shown in FIG. 1;

FIG. 3 is a planar view of the keyboard instrument set shown in FIG. 1;

FIG. 4 is a side view of the keyboard instrument set shown in FIG. 1;

FIG. 5 is a perspective view showing the stand of the keyboard instrument set shown in FIG. 1;

FIG. 6 is a perspective view showing a state where the connection members of a lateral-bridging member are attached to the top ends of the pedal frames of the stand in FIG. 5 with the pedal frames being laid down;

FIG. 7 is an exploded perspective view showing a state where leg sections are attached to the leg attachment sections of the connection members shown in FIG. 6;

FIG. 8A is an exploded perspective view of a main portion shown in FIG. 7;

FIG. 8B is an enlarged perspective view showing the main portion of the right leg section;

FIG. 8C is an enlarged perspective view showing the main portion of the left leg section;

FIG. 9 is an enlarged perspective view of the main portion where the leg section has been positioned on the leg attachment section of the connection member in FIG. 8A;

FIG. 10 is a perspective view showing the lower side of the main portion when the leg section is attached to the leg attachment section of the connection member in FIG. 9.

### DETAILED DESCRIPTION OF THE PREFERRED EMBODIMENT

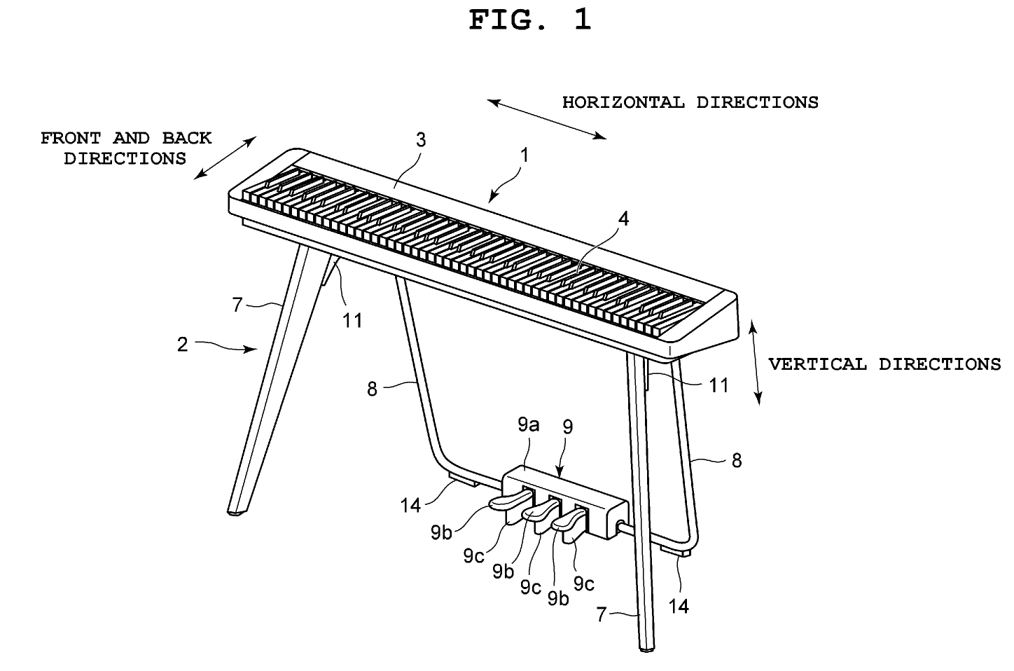

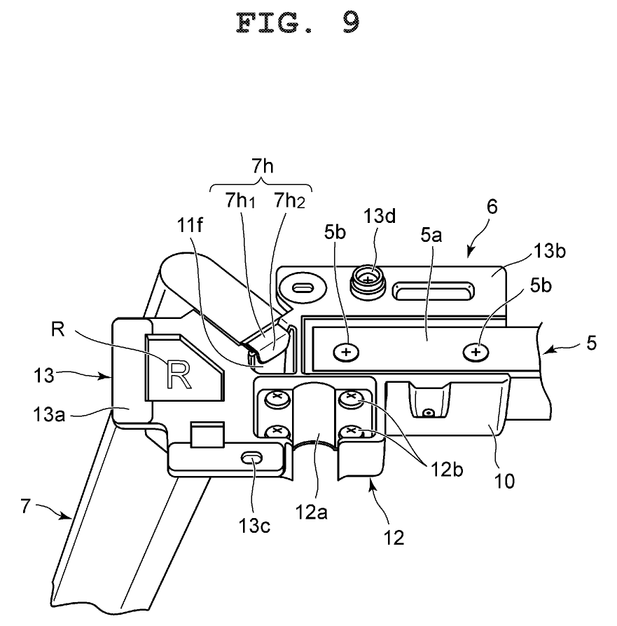

An embodiment where the present disclosure has been applied in a keyboard instrument set will hereinafter be described with reference to FIG. 1 to FIG. 10.

This keyboard instrument set includes a keyboard instrument 1 and a stand 2, as shown in FIG. 1 to FIG. 4. The keyboard instrument 1 includes an instrument case 3 which is long in a lateral direction that is a horizontal direction. In the instrument case 3, a keyboard section 4 is provided in which a plurality of white keys and a plurality of black keys are arranged in a longitudinal direction that is a horizontal direction.

The stand 2 includes a lateral-bridging member 5 having a rectangular pipe shape which is long in a lateral direction that is a horizontal direction and on which the keyboard instrument 1 is arranged, two connection members 6 which are provided on end sections 5a at the sides of the lateral-bridging member 5 in a lateral direction that is a horizontal direction, two leg sections 7 which are attached to the connection members 6 at the sides and support the front side of the keyboard instrument 1, pedal frames 8 which are attached to the connection members 6 at the sides and support the back side of the keyboard instrument 1, and a pedal device 9 which is fixed to the pedal frames 8, as shown in FIG. 1 to FIG. 5.

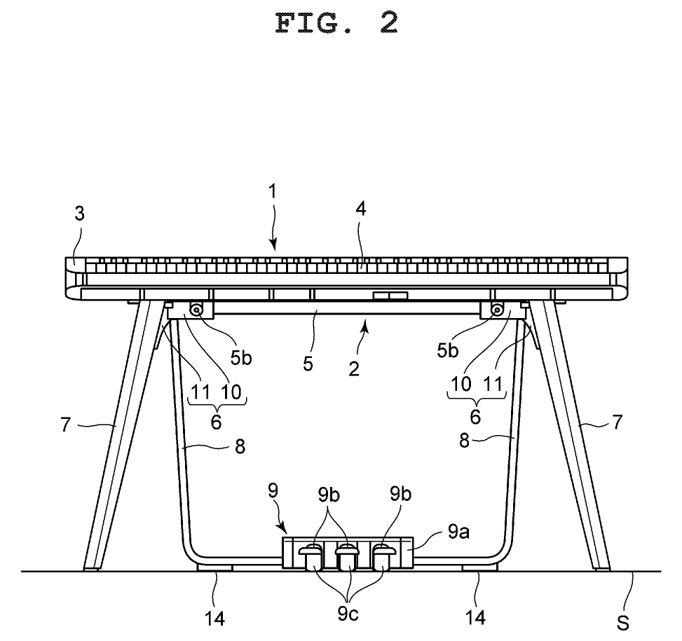

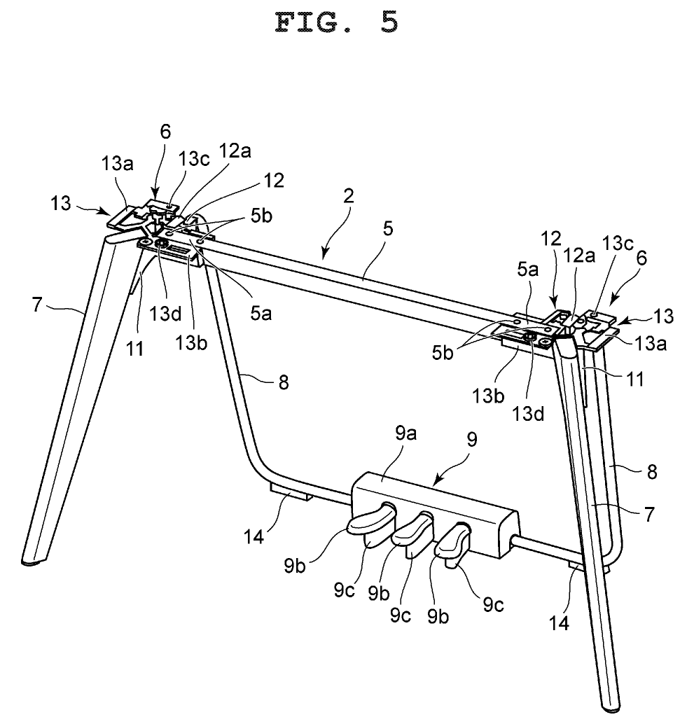

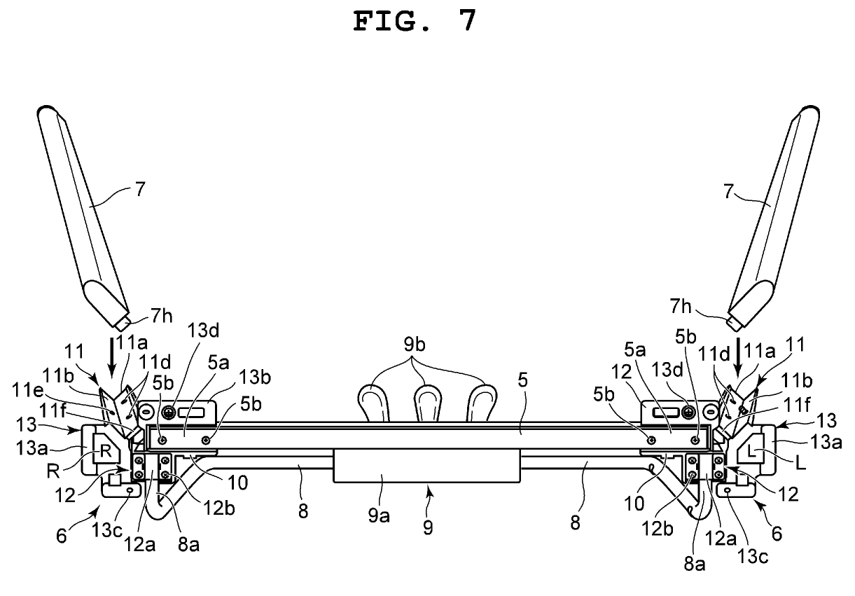

Each of the two connection members 6 includes a lateral-bridging attachment section 10 to which one of the end sections 5a at the sides of the lateral-bridging member 5 in horizontal directions is attached, a leg attachment section 11 to which the upper part of the corresponding leg section 7 is attached, a frame attachment section 12 to which a top end section 8a of the corresponding pedal frame 8 is attached, a musical instrument mounting section 13 where the undersurface of the keyboard instrument 1 is positioned and arranged, as shown in FIG. 5 to FIG. 10. The lateral-bridging attachment section 10 is structured such that the corresponding end section 5a located at a side portion of the lateral-bridging member 5 in a lateral direction that is a horizontal direction is inserted thereinto from above, and the upper, lower, front, and back surfaces of the end section 5a is attached thereto by a plurality of screws 5b (refer to FIG. 2 and FIG. 7).

The leg attachment section 11 has an L shape when viewed from below, as shown in FIG. 5 to FIG. 7 and FIG. 10. This leg attachment section 11 includes a first receiving surface 11a and a second receiving surface 11b which are perpendicular to each other and to which the corresponding leg section 7 is attached. The first receiving surface 11a of the leg attachment section 11 extends, in an obliquely lower direction, outward with respect to the corresponding end of the keyboard instrument 1 in a longitudinal direction that is a horizontal direction. Also, the second receiving surface 11b of this leg attachment section 11 extends, in an obliquely lower direction, toward the front side of the keyboard instrument 1 in a front direction that is a transverse direction.

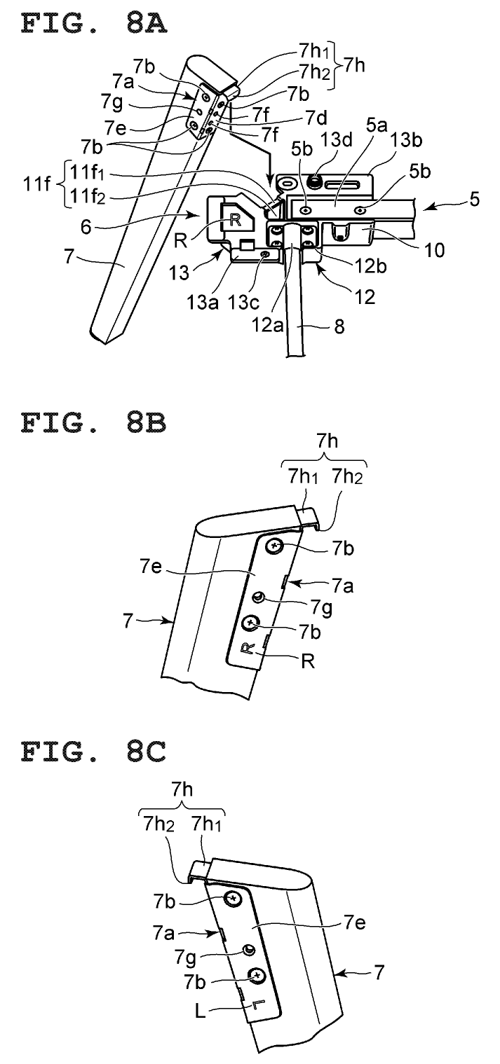

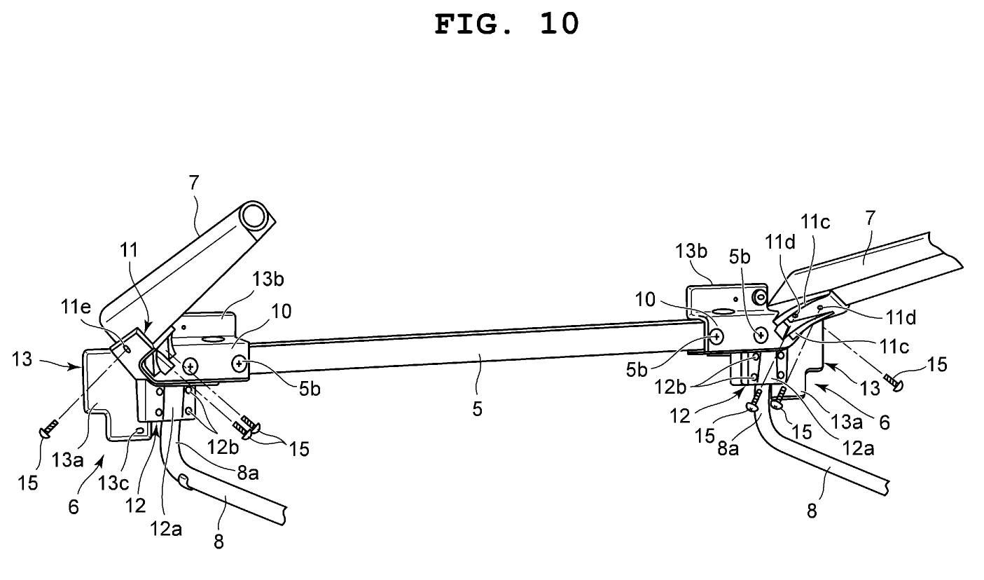

On the outer surface of the first receiving surface 11a, that is, on the back surface of the first receiving surface 11a to which the leg section 7 is attached, a plurality of reinforcement ribs 11c extending in a vertical direction is provided, as shown in FIG. 7 and FIG. 10. In two portions, or more specifically, in upper and lower portions of the first receiving surface 11a, first attachment holes 11d are formed to be positioned between the plurality of reinforcement ribs 11c. Also, in a substantially middle portion of the second receiving surface 11b in a vertical direction, a second attachment hole 11e is formed. Moreover, to a corner portion of the upper part of the leg section 7, an L-shaped reinforcement bracket 7a is attached by a plurality of screws 7b, which is opposed to the first receiving surface 11a and second receiving surface 11b of the leg attachment section 11 that are perpendicular to each other, as shown in FIG. 7, and FIG. 8A to FIG. 8C.

The L-shaped reinforcement bracket 7a is provided with a first attachment surface 7d which is opposed to the first receiving surface 11a of the leg attachment section 11, and a second attachment surface 7e which is opposed to the second receiving surface 11b of the leg attachment section 11. In the first attachment surface 7d of the reinforcement bracket 7a, two upper and lower first screw holes 7f corresponding to the two first attachment holes 11d in the first receiving surface 11a of the leg attachment section 11 are formed. Also, in the second attachment surface 7e of the reinforcement bracket 7a, a second screw hole 7g corresponding to the second attachment hole 11e in the second receiving surface 11b of the leg attachment section 11 is formed.

When the reinforcement bracket 7a on the upper part is arranged on the leg attachment section 11 of the corresponding connection member 6, the two surfaces of the reinforcement bracket 7a, that is, the first attachment surface 7d and the second attachment surface 7e which are perpendicular to each other are opposed to the two surfaces of the leg attachment section 11, that is, the first receiving surface 11a and the second receiving surface 11b which are perpendicular to each, as shown in FIG. 7, and FIG. 8A to FIG. 8C. Accordingly, the reinforcement bracket 7a is covered by the first receiving surface 11a and second receiving surface 11b of the leg attachment section 11 of the connection member 6 perpendicular to each other so as not to be seen from the outside. In this state, the two first screw holes 7f of the reinforcement bracket 7a correspond to the two first attachment holes 11d of the first receiving surface 11a, and the second screw hole 7g of the reinforcement bracket 7a corresponds to the second attachment hole 11e of the second receiving surface 11b.

Also, two screw members 15 which are fastening members are screwed into the two first screw holes 7f of the first attachment surface 7d of the reinforcement bracket 7a through the first attachment holes 11d of the first receiving surface 11a, and another screw member 15 is screwed into the second screw hole 7g of the second attachment surface 7e of the reinforcement bracket 7a through the second attachment hole 11e of the second receiving surface 11b, as shown in FIG. 10. As such, the leg section 7 is attached to the leg attachment section 11 of the connection member 6 by the screw members 15 on one side and the screw member 15 on the other side being tightened on the reinforcement bracket 7a,

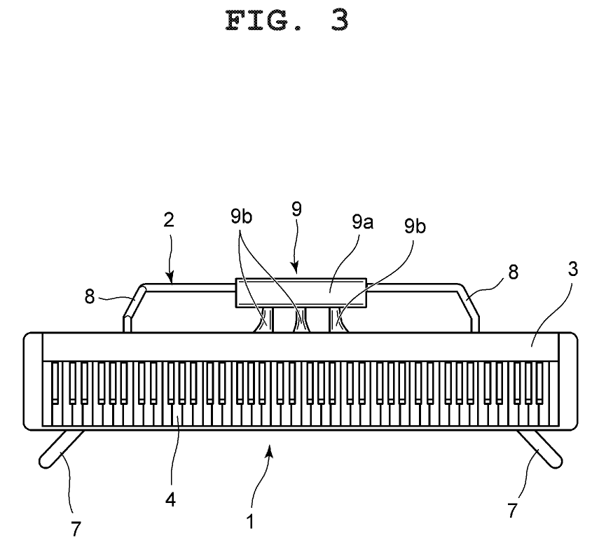

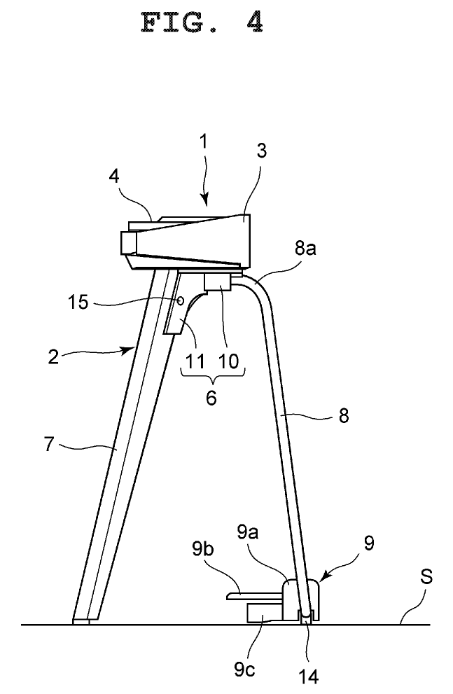

In addition, when attached to the leg attachment sections 11 of the connection members 6 located on the sides of the lateral-bridging member 5 by the screw members 15 on one side and the screw member 15 on the other side as shown in FIG. 5 to FIG. 8C and FIG. 10, the two leg sections 7 extend, in obliquely lower directions, outward with respect to the ends of the keyboard instrument 1 in longitudinal directions that are horizontal directions, and frontward with respect to the keyboard instrument 1 in a back-to-front direction that is a transverse direction so as to extend apart from the keyboard instrument 1 in the outward and frontward directions, as shown in FIG. 3 and FIG. 4.

Also, on a top end portion of the first attachment surface 7d of each reinforcement bracket 7a, an engaging hook 7h which is a hook-shaped engaging section is provided, as shown in FIG. 7 to FIG. 9. This engaging hook 7h engages with an engaging recess section 11f which is an engaging target section formed in a top end portion of the first receiving surface 11a of each leg attachment section 11, and thereby positions the corresponding leg section 7 on the leg attachment section 11. In the present embodiment, the top end of each leg section 7 and the main surface on the top side of each connection member 6 (the upper surface of the musical instrument mounting section 13) are at substantially the same height when viewed from the side.

Each engaging hook 7h includes a first portion 7h1 which is at substantially the same height as the main surface on the top side of each connection member 6 (the upper surface of each musical instrument mounting section 13), and a second portion 7h2 which is substantially vertical to the main surface on the top side of each connection member 6 (the upper surface of each musical instrument mounting section 13), as shown in FIG. 7 to FIG. 9. Also, each engaging recess section 11f includes a first groove portion 11f1 which corresponds to the first portion 7h1 of the corresponding engaging hook 7h, and a second groove section 11f2 which corresponds to the second portion 7h2 of the corresponding engaging hook 7h.

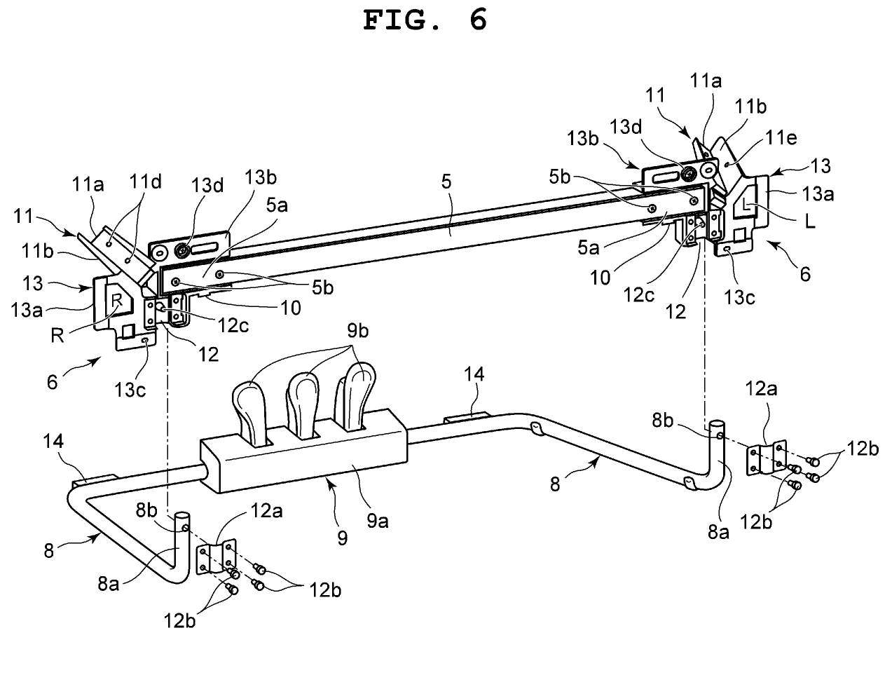

In the present embodiment, when the engaging hook 7h of the reinforcement bracket 7a of each leg section 7 is to engage with the engaging recess section 11f of the leg attachment section 11 of the corresponding connection member 6 after the leg section 7 is arranged on the leg attachment section 11 with the corresponding pedal frame 8 holding the main surface on the top side of the connection member 6 such that the main surface is substantially vertical to a setting surface S, that is, with the pedal frame 8 being laid down and the leg attachment section 11 extending obliquely upward at an inclination angle of about 30 degrees, the second portion 7h2 of the engaging hook 7h engages with the second groove section 11f2 of the engaging recess section 11f by the rotational moment of the leg section 7 acting vertically from the gravity center of the leg section 7 due to gravity, as shown in FIG. 6, FIG. 7, and FIG. 10. As a result of this structure, when arranged on the leg attachment section 11, the leg section 7 is positioned and held on the leg attachment section 11 by the engaging hook 7h engaging with the engaging recess section 11f, without falling off the leg attachment section 11 due to the rotational moment. Note that, in order to increase the engaging force of the second portion 7h2 engaging with the second groove section 11f2 of the engaging recess section 11f, this structure should preferably be designed such that the gravity center of the leg section 7 is maintained at a portion where the leg section 7 does not come in contact with the leg attachment section 11 (the first receiving surface 11a and the second receiving surface 11b).

Also, the present embodiment is structured such that, when each pedal frame 8 is holding the main surface on the top side of the corresponding connection member 6 such that the main surface is substantially vertical to the setting surface S, that is, when each pedal frame 8 is being laid down and the corresponding leg attachment section 11 is extending obliquely upward at an inclination angle of about 30 degrees, the static friction force between each leg section 7 and the corresponding leg attachment section 11, that is, the static friction force between the first and second attachment surfaces 7d and 7e of the reinforcement bracket 7a of each leg section 7 and the first and second receiving surfaces 11a and 11b of the corresponding leg attachment section 11 corresponding thereto is greater than the gravity component of the leg section 7 in the extending direction of the leg attachment section 11 (which is, the component of the force acting vertically from the gravity center of the leg section 7), as shown in FIG. 6, FIG. 7, and FIG. 10.

As a result of this structure, when arranged on the corresponding leg attachment section 11, each leg section 7 is positioned and held on the leg attachment section 11 by static friction force without slipping off by the gravity component. Note that the static friction force in the present embodiment is adjusted by the degree of a force with which the second portion 7h2 of each engaging hook 7h engages with the second groove section 11f2 of the corresponding engaging recess section 11f, and a force associated therewith with which the first attachment surface 7d and second attachment surface 7e of each leg section 7 are moved to corresponding the first receiving surface 11a and the corresponding second receiving surface 11b. Also, the static friction force is adjustable by the angles of the first receiving surface 11a and the second receiving surface 11b being adjusted or coating processing being performed on the surface of the leg section 7.

That is, when arranged on the corresponding leg attachment section 11, each leg section 7 is positioned and held on the leg attachment section 11 by the engaging hook 7h thereon engaging with the corresponding engaging recess section 11f by the rolling moment and the like, and by the static friction force between the leg section 7 and the leg attachment section 11, as shown in FIG. 6 and FIG. 7. As a result of this structure, when arranged on the leg attachment section 11 of the corresponding connection member 6, each leg section 7 is attached to the leg attachment section 11 by the screw members 15 which are fastening members while being held on the leg attachment section 11 without falling or slipping off the leg attachment section 11.

On the leg sections 7 and the connection members 6 which support two right and left portions of the front side of the keyboard instrument 1, sign sections R and sign sections L are provided to indicate whether components with these sign sections are on the right side or the left side, as shown in FIG. 6 to FIG. 9. More specifically, of these sign sections R and L, the sign sections R are provided on the second attachment surface 7e of the reinforcement bracket 7a on the leg section 7 on the right side and the upper surface of a side mounting section 13a of the musical instrument mounting section 13 in the connection member 6 on the right side. Also, the sign sections L are provided on the second attachment surface 7e of the reinforcement bracket 7a on the leg section 7 on the left side and the upper surface of a side mounting section 13a of the musical instrument mounting section 13 in the connection member 6 on the left side. These sign sections R and L are covered by the leg attachment sections 11 and the keyboard instrument 1 when the leg sections 7 are attached to the connection members 6 and the keyboard instrument 1 is arranged on the musical instrument mounting sections 13 of the connection members 6.

On the other hand, the frame attachment section 12 of each connection member 6 includes a retaining bracket 12a which holds down the top end of the corresponding pedal frame 8, as shown in FIG. 5 to FIG. 7. This retaining bracket 12a is attached to the frame attachment section 12 by a plurality of screws 12b while positioning and holding down the top end section 8a of the pedal frame 8 on the frame attachment section 12. In the top end section 8a of each pedal frame 8, a positioning hole 8b is formed. In addition, on each frame attachment section 12, a positioning pin 12c is formed which is inserted into the corresponding positioning hole 8b. The pedal frames 8 are constituted by two bar-shaped members extending upward from the sides of the pedal device 9 in longitudinal directions and thereby having a substantially inverted trapezoidal shape when viewed from the front of the keyboard instrument 1, as shown in FIG. 2. These pedal frames 8 are arranged posterior to the leg sections 7 while extending posterior to the keyboard instrument 1 so as to be apart from the leg sections 7, as shown in FIG. 3 and FIG. 4.

Also, the pedal frames 8 are formed such that their total width in a longitudinal direction of the keyboard instrument 1 is long enough to be close to the total width between the leg sections 7, as shown in FIG. 2. That is, the pedal frames 8 are formed such that their total width in a longitudinal direction of the keyboard instrument 1 is slightly shorter than the total width between the leg sections 7. Moreover, on two portions of the pedal frames 8 located to the sides of the pedal device 9 in an horizontal direction which is a longitudinal direction, antislip members 14 are provided. These antislip members 14 are arranged in contact with the setting surface S where the stand 2 is installed, and prevent the stand 2 from slipping.

The pedal device 9 includes a device main body 9a having a box shape which is long in a lateral direction that is a longitudinal direction of the keyboard instrument 1, and three pedals 9b which are arranged in a lateral direction that is a longitudinal direction of the device main body 9a while projecting frontward from the device main body 9a, as shown in FIG. 1 to FIG. 5. Under these three pedals 9b, projection sections 9c are provided extending frontward from the main device body 9a. These projection sections 9c are provided with installation adjusting members (not shown in the drawings) which adjust contact with the setting surface S.

Each musical instrument mounting section 13 of the two connection members 6, on which the keyboard instrument 1 is mounted, includes a front mounting section 13b which projects toward the front side of the keyboard instrument 1, and the side mounting section 13a which projects in a lateral direction that is a longitudinal direction of the keyboard instrument 1, as shown in FIG. 5 to FIG. 8. Each side mounting section 13a includes a fixation hole 13c for fixing the undersurface of an end portion of the keyboard instrument 1 in a longitudinal direction by a screw. Also, each front mounting section 13b includes a positioning pin 13d which positions the undersurface of the keyboard instrument 1.

Next, the assembly of this keyboard instrument set is described.

In this assembly, first, the stand 2 is assembled. An assembly method for this stand 2 includes a first step of assembling the pedal frames 8, a second step of attaching the connection members 6 attached to the sides of the lateral-bridging member 5 to the assembled pedal frames 8 with the pedal frames 8 being laid down, and a third step of attaching the leg sections 7 to the connection members 6 attached to the pedal frames 8 which have been laid down. At the first step, the pedal device 9 is attached to the pedal frames 8, and the antislip members 14 are attached to the side portions of the pedal frames 8 located to the sides of the pedal device 9.

At the second step, the top end section 8a of a side of each pedal frame 8 is oriented upward so that the pedal frames 8 are laid down on the setting surface S such as a floor. More specifically, the pedal frames 8 hold the main surfaces on the top sides of the connection members 6 such that the main surfaces are substantially vertical to the setting surface S. In this state, the frame attachment sections 12 of the two connection members 6 of the lateral-bridging member 5 are attached to the top end sections 8a of the pedal frames 8 on both sides. Here, before this attachment, the connection members 6 are attached to the end sections 5a of the lateral-bridging member 5 in the horizontal directions. In this attachment, the end sections 5a of the sides of the lateral-bridging member 5 are fitted into the lateral-bridging attachment sections 10 of the two connection members 6 from above and, in this state, attached to the upper and lower surfaces of the lateral-bridging attachment sections 10 and the side surfaces thereof in the front and back directions by the plurality of screws 5b.

Next, the lateral-bridging member 5 is attached to the pedal frames 8 via the two connection members 6 with the pedal frames 8 being laid down on the setting surface S (refer to FIG. 2) such as a floor, that is, with the pedal frames 8 holding the main surfaces on the top sides of the connection members 6 such that the main surfaces are substantially vertical to the setting surface S. Here, the positioning pins 12c of the frame attachment sections 12 of the connection members 6 are inserted into the positioning holes 8b in the top end sections 8a of the pedal frames 8. Consequently, the top end sections 8a of the pedal frames 8 are positioned on the frame attachment sections 12 of the connection members 6, and then held down by the retaining brackets 12a. In this state, by the plurality of screws 12b, the retaining brackets 12a are attached to the frame attachment sections 12. Here, the leg attachment sections 11 of the two connection members 6 are arranged while being inclined obliquely upward at an inclination angle of about 30 degrees, with the pedal frames 8 being laid down on the setting surface S such as a floor.

Then, the leg sections 7 are attached to the leg attachment sections 11 of the two connection members 6 attached to the ends of the lateral-bridging member 5. Here, before this attachment, the L-shaped reinforcement brackets 7a are attached to corners of the upper parts of the leg sections 7 by the plurality of screws 7b. Subsequently, each L-shaped reinforcement bracket 7a attached as described above to the upper part of the corresponding leg section 7 is arranged inside the L-shaped leg attachment section 11 of the corresponding connection member 6, whereby the two surfaces of each reinforcement bracket 7a, that is, the first attachment surface 7d and the second attachment surface 7e perpendicular to each other are opposed to the two surfaces of the corresponding leg attachment section 11, that is, the first receiving surface 11a and the second receiving surface 11b perpendicular to each other. In this state, the two first screw holes 7f of each reinforcement bracket 7a are corresponding to the two first attachment holes 11d of the corresponding first receiving surface 11a, and the second screw hole 7g of each reinforcement bracket 7a is corresponding to the second attachment hole 11e of the corresponding second receiving surface 11b.

As a result, the reinforcement brackets 7a and the sign sections (R, L) are covered by the first receiving surface 11a and second receiving surface 11b of each leg attachment section 11 of the connection members 6 perpendicular to each other so as not to be seen from the outside. Here, the leg sections 7 are positioned and held on the leg attachment sections 11 by the static friction force between each leg section 7 and the corresponding leg attachment section 11, with the engaging hooks 7h engaging with the engaging recess sections 11f by the rotational moment. Accordingly, the leg sections 7 are attached to the leg attachment sections 11 of the connection members 6 by the screw members 15 which are fastening members without falling or slipping off the leg attachment sections 11.

More specifically, the two screw members 15 which are fastening members on one side are screwed into the two first screw holes 7f in the first attachment surface 7d of each reinforcement bracket 7a through the first attachment holes 11d of the corresponding first receiving surface 11a, and the screw member 15 on the other side is screwed into the second screw hole 7g through the second attachment hole 11e of the corresponding second receiving surface 11b. In this state, when the screw members 15 on the one side and the other side are tightened, each leg section 7 is attached to the leg attachment section 11 of the corresponding connection member 6. As a result, the assembly of the stand 2 is completed which supports the front and back sides of the keyboard instrument 1 by the two leg sections 7 and the pedal frames 8.

In this state, the stand 2 is set upright on the setting surface S such as a floor by the two leg sections 7 and the pedal frames 8. Then, the side parts of the undersurface of the keyboard instrument 1 in horizontal directions which are longitudinal directions are arranged on the musical instrument mounting sections 13 provided on the two connection members 6 of the stand 2. Here, the undersurfaces of the sides of the keyboard instrument 1 in the horizontal directions are positioned by the positioning pins 13d provided on the front mounting sections 13b of the two musical instrument mounting sections 13. In this state, when screw members (not shown in the drawings) are screwed into the undersurface of the keyboard instrument 1 from below through the fixation holes 13c in the two front mounting sections 13a, the keyboard instrument 1 is attached to the stand 2.

In this state, the contact state of the pedal device 9 with respect to the setting surface S is adjusted by the installation adjusting members (not shown in the drawings) of the pedal device 9. As a result, the assembly of the keyboard instrument set is completed. In this state, the two leg sections 7 are extending, in obliquely lower directions, outward with respect to the ends of the keyboard instrument 1 in the longitudinal directions that are the horizontal directions, and frontward with respect to the keyboard instrument 1 in the back-to-front direction that is the transverse direction so as to extend apart from the keyboard instrument 1 in the outward and frontward directions, as shown in FIG. 3 and FIG. 4. That is, the two leg sections 7 extend apart from the keyboard instrument 1 in obliquely frontward directions, and thereby stably and reliably support the front side of the keyboard instrument 1. Also, here, the two pedal frames 8 are arranged posterior to the leg sections 7 while extending posterior to the keyboard instrument 1 so as to be apart from the leg sections 7, and thereby stably and reliably support the back side of the keyboard instrument 1.

Here, in the case of the stand having the four-legged structure described in Japanese Patent Application Laid-Open (Kokai) Publication No. 2023-157063, the two front leg sections and the two back leg sections are required to be individually provided on the connection members on the ends of the lateral-bridging member, and pedal frames to which a pedal device is fixed are required to be attached to the lateral-bridging member by the connection members. Accordingly, this structure is complicated and has a problem in that the assembly work is cumbersome.

In contrast, the stand 2 of the keyboard instrument set in the present embodiment includes the lateral-bridging member 5, each leg section 7 which supports at least the front

side that is one side of the front and back sides of the keyboard instrument 1, and each connection member 6 which connects the lateral-bridging member 5 with the corresponding leg section 7, in which each leg section 7 has the engaging hook 7h which is a hook-shaped engaging section provided at one end portion, and each connection member 6 has the engaging recess section 11f which is an engaging target member corresponding to the engaging hook 7h. As a result, the simple structure is achieved, and the assembly work is improved.

That is, in the case of the stand 2 of this keyboard instrument set, the engaging hooks 7h of the leg sections 7 engage with the engaging recess sections 11f of the connection members 6. Therefore, when being attached to the connection members 6, the leg sections 7 are positioned and held on the connection members 6. As a result of this structure, the leg sections 7 can be easily attached to the connection members 6, which enables the structure to be simple and the assembly work to be improved.

Also, in the case of the stand 2 of this keyboard instrument set, one end portion of each leg section 7 has a flat surface that is at substantially the same height as the upper surface of the musical instrument mounting section 13 of the corresponding connection member 6 which is a mounting surface for the keyboard instrument 1 and, in a planar view from the side, each engaging hook 7h which is an engaging section is provided at a position at the same height as or lower than the flat surface that is at substantially the same height as the upper surface of the musical instrument mounting section 13 of the corresponding connection member 6 which is the mounting surface for the keyboard instrument 1. As a result of this structure, the engaging hooks 7h do not cause an obstruction when the keyboard instrument 1 is arranged on the upper surfaces of the musical instrument mounting sections 13, and the installation area of the keyboard instrument 1 is increased, whereby the keyboard instrument 1 is stably arranged.

Moreover, in the case of the stand 2 of this keyboard instrument set, one end of each leg section 7 and the main surface on the top side of the corresponding connection member 6 are at substantially the same height in a planar view from the side, and each engaging hook 7h includes the first portion 7h1 which is at substantially the same height as the main surface on the top side of the corresponding connection member 6 in a planar view from the side, and the second portion 7h2 which is substantially vertical to the main surface on the top side of the connection member 6 in a planar view from the side . In addition, each engaging recess section 11f includes the first groove portion 11f1 which corresponds to the first portion 7h1, and the second groove section 11f2 which corresponds to the second portion 7h2. As a result of this structure, the engaging hooks 7h reliably and favorably engage with the engaging recess sections 11f of the connection members 6 without each engaging hook 7h projecting above the main surface on the top side of the corresponding connection member 6 and the leg sections 7 and the engaging hooks 7h being unintentionally shifted sideways.

Furthermore, in the case of the stand 2 of this keyboard instrument set, each leg section 7 obliquely extends at least in a front direction which is one of the front and back directions from the keyboard instrument 1 in a planar view from above, and each connection member 6 includes the leg attachment section 11 which supports one end side of the corresponding leg section 7. By being positioned by the engaging hooks 7h and the leg attachment sections 11, the leg sections 7 obliquely extend frontward from the keyboard instrument 1. As a result of this structure, the leg sections 7 are accurately and favorably attached to the leg attachment sections 11.

In the present embodiment, the stand 2 of the keyboard instrument set includes each leg section 7 which supports at least the front side that is one side of the front and back sides of the keyboard instrument 1, and each pedal frame 8 which supports at least the back side that is the other side of the front and back sides of the keyboard instrument 1, and the static friction force component between each leg section 7 and the corresponding leg attachment section 11 in the extending direction of the leg attachment section 11 when each pedal frame 8 is holding the main surface on the top side of the corresponding connection member 6 such that the main surface is substantially vertical to the setting surface S, that is, when each pedal frame 8 has been laid down is greater than the gravity component of each leg section 7 in the extending direction of the corresponding leg attachment section 11. Accordingly, even though the leg attachment sections 11 are obliquely inclined, the leg sections 7 are favorably held on the leg attachment sections 11 by the static friction force component so as not to slip off the leg attachment sections 11 when arranged on the leg attachment sections 11. In the case of the conventional technique, these leg sections slip off, and screws cannot be easily tightened. However, in the case of the present disclosure, the leg sections 7 are only required to be placed on the leg attachment sections 11, and do not slip off the leg attachment sections 11. Therefore, screws can be easily tightened for the leg sections 7. These leg sections are heavy and difficult to be assembled by one person alone in the conventional technique. However, the present disclosure enables the leg sections to be assembled by one person alone.

Also, this stand 2 of the keyboard instrument set includes each leg section 7 which supports at least the front side that is one side of the front and back sides of the keyboard instrument 1, and each pedal frame 8 which supports at least the back side that is the other side of the front and back sides of the keyboard instrument 1, and the engaging hook 7h of each leg section 7 engages with the engaging recess section 11f of the corresponding connection member by the rotational moment of the leg section 7 centering on the gravity center of the leg section 7 with each pedal frame 8 holding the main surface on the top side of the corresponding connection member 6 such that the main surface is substantially vertical to the setting surface S, that is, with each pedal frame 8 being laid down. As a result of this structure, even though the leg attachment sections 11 are obliquely inclined, the leg sections 7 are favorably held on the leg attachment sections 11 by the engaging hooks 7h engaging with the engaging recess sections 11f so as not to slip off the leg attachment sections 11 due to the rotational moment of each leg section 7 when the leg sections 7 are arranged on the leg attachment sections 11.

Moreover, in the case of the stand 2 of this keyboard instrument set, the leg sections 7 support two right and left portions of at least the front side that is one of the front and back sides of the keyboard instrument 1, and the sign section R and the sign section L are provided on each leg section 7 so as to indicate whether the leg section 7 is a right side member or a left side member. When the leg sections 7 are attached to the connection members 6, these sign sections R and L are covered by the leg attachment sections 11. However, before this attachment, the right side leg section 7 and the left side leg section 7 can be distinguished from each other by the sign sections R and L even if they have different shapes, and prevented from being incorrectly attached. Also, after being attached, the sign sections R and the sign sections L are covered by the leg attachment sections 11, which enhances the design.

Also, the assembly method for this stand 2 includes the first step of assembling the pedal frames 8, the second step of attaching the connection members 6 attached to the sides of the lateral-bridging member 5 to the assembled pedal frames 8 with the pedal frames 8 being laid down, that is, with each pedal frame 8 holding the main surface on the top side of the corresponding connection member 6 such that the main surface is substantially vertical to the setting surface S, and the third step of attaching the leg sections 7 to the connection members 6 attached to the pedal frames 8 which have been laid down, whereby the simple structure is achieved, and the assembly work is improved.

More specifically, in the assembly method for this stand 2, at the second step, the connection members 6 of the lateral-bridging member 5 are attached to the pedal frames 8 with the pedal frames 8 being laid down. Thus, the connection members 6 can be easily attached to the pedal frames 8 by one worker alone, which improves the assembly work. In addition, at the third step, the leg sections 7 are attached to the connection members 6 attached to the pedal frames 8. Accordingly, the leg sections 7 can be easily attached to the connection members 6 by one worker alone, which improves the assembly work.

In this assembly method for the stand 2 in the present embodiment, at the third step, the leg sections 7 are attached to the connection members 6 with each engaging hook 7h provided on one end portion of the corresponding leg section 7 engaging with the engaging recess section 11f of the corresponding connection member 6. That is, when being attached to the connection members 6, the leg sections 7 can be positioned and held on the connection members 6 by the engaging hooks 7h of the leg sections 7 engaging with the engaging recess sections 11f of the connection members 6. Then, in this state, each leg section 7 is attached to the corresponding connection member 6. Thus, the leg sections 7 can be easily attached to the connection members 6 by one worker alone, which improves the assembly work.

In the above-described embodiment, the pedal frames 8 have a substantially inverted trapezoidal shape as a whole. However, the present disclosure is not limited thereto, and the pedal frames 8 may have a square shape or a rectangular shape as a whole.

Also, in the above-described embodiment, the pedal frames 8 are constituted by two bar-shaped members. However, the present disclosure is not limited thereto, and a pedal frame having a plate shape may be adopted.

While the present disclosure has been described with reference to the preferred embodiments, it is intended that the disclosure be not limited by any of the details of the description therein but includes all the embodiments which fall within the scope of the appended claims.

What is claimed is:

1. A stand comprising:
a lateral-bridging member;
a leg section which supports at least one side of front and back sides of a keyboard instrument; and
a connection member which connects the lateral-bridging member with the leg section,
wherein the leg section includes a hook-shaped engaging section provided at one end portion, and
wherein the connection member includes an engaging target section corresponding to the hook-shaped engaging section.

2. The stand according to claim 1, wherein one end portion of the leg section has a flat surface that is at substantially same height as a mounting surface for the keyboard instrument, and
wherein the engaging section is provided at a position at same height as or lower than the flat surface that is at substantially the same height as the mounting surface, in a planar view from a side.

3. The stand according to claim 2, wherein the one end of the leg section and a main surface on a top side of the connection member are at substantially same height in the planar view from the side, and
wherein the hook-shaped engaging section includes a first portion which is at substantially the same height as the main surface on the top side of the connection member in the planar view from the side, and a second portion which is substantially vertical to the main surface on the top side of the connection member 6 in the planar view from the side, and
wherein the engaging target section includes a first groove section which corresponds to the first portion, and a second groove section which corresponds to the second portion.

4. The stand according to claim 1, wherein the leg section obliquely extends at least in one of front and back directions from the keyboard instrument in a planar view from above,
wherein the connection member includes a leg attachment section which supports one end side of the leg section, and
wherein the leg section is positioned by the engaging section and the leg attachment section.

5. The stand according to claim 4, further comprising:
a pedal frame which supports at least an other side of the front and back sides of the keyboard instrument,
wherein a static friction force component between the leg section and the leg attachment section in an extending direction of the leg attachment section when the pedal frame is holding a main surface on a top side of the connection member such that the main surface is substantially vertical to a stand setting surface is greater than a gravity component of the leg section in the extending direction of the leg attachment section.

6. The stand according to claim 4, further comprising:
a pedal frame which supports at least an other side of the front and back sides of the keyboard instrument,
wherein the engaging section of the leg section engages with the engaging target section of the connection member by a rotational moment of the leg section acting vertically from gravity center of the leg section, with the pedal frame holding a main surface on a top side of the connection member such that the main surface is substantially vertical to a stand setting surface.

7. The stand according to claim 4, wherein the leg section is plurally provided, and leg sections support two right and left portions of at least one side of the front and back sides of the keyboard instrument,
wherein the leg sections are provided with sign sections indicating whether each leg section is a right side member or a left side member, and
wherein the sign sections are covered by the leg attachment section when the leg sections are attached to the connection member.

8. A stand assembly method comprising:
assembling a pedal frame;
attaching connection members attached to sides of a lateral-bridging member to the assembled pedal frame with the pedal frame being laid down; and
attaching leg sections to the connection members attached to the pedal frame which has been laid down.

9. The stand assembly method according to claim 8, wherein the leg section is attached to the connection member with a hook-shaped engaging section provided on one end portion of the leg section engaging with an engaging target section on the connection member.

10. A keyboard instrument set comprising:
a stand; and
a keyboard instrument,
wherein the stand includes:
a lateral-bridging member;
a leg section which supports at least one side of front and back sides of a keyboard instrument; and
a connection member which connects the lateral-bridging member with the leg section,
wherein the leg section includes a hook-shaped engaging section provided at one end portion, and
wherein the connection member includes an engaging target section corresponding to the hook-shaped engaging section.

11. The keyboard instrument set according to claim 10, wherein one end portion of the leg section has a flat surface that is at substantially same height as a mounting surface for the keyboard instrument, and
wherein the engaging section is provided at a position at same height as or lower than the flat surface that is at substantially the same height as the mounting surface, in a planar view from a side.

12. The keyboard instrument set according to claim 11, wherein the one end of the leg section and a main surface on a top side of the connection member are at substantially same height in the planar view from the side, and
wherein the hook-shaped engaging section includes a first portion which is at substantially same height as the main surface on the top side of the connection member in the planar view from the side, and a second portion which is substantially vertical to the main surface on the top side of the connection member 6 in the planar view from the side, and
wherein the engaging target section includes a first groove section which corresponds to the first portion, and a second groove section which corresponds to the second portion.

13. The keyboard instrument set according to claim 10, wherein the leg section obliquely extends at least in one of front and back directions from the keyboard instrument in a planar view from above,
wherein the connection member includes a leg attachment section which supports one end side of the leg section, and
wherein the leg section is positioned by the engaging section and the leg attachment section.

14. The keyboard instrument set according to claim 13, wherein the stand includes a pedal frame which supports at least an other side of the front and back sides of the keyboard instrument,
wherein a static friction force component between the leg section and the leg attachment section in an extending direction of the leg attachment section when the pedal frame is holding a main surface on a top side of the connection member such that the main surface is substantially vertical to a stand setting surface is greater than a gravity component of the leg section in the extending direction of the leg attachment section.

15. The keyboard instrument set according to claim 13, wherein the stand includes a pedal frame which supports at least an other side of the front and back sides of the keyboard instrument,
wherein the engaging section of the leg section engages with the engaging target section of the connection member by a rotational moment of the leg section acting vertically from gravity center of the leg section, with the pedal frame holding a main surface on a top side of the connection member such that the main surface is substantially vertical to a stand setting surface.

16. The keyboard instrument set according to claim 13, wherein the leg section is plurally provided, and leg sections support two right and left portions of at least one side of the front and back sides of the keyboard instrument,
wherein the leg sections are provided with sign sections indicating whether each leg section is a right side member or a left side member, and
wherein the sign sections are covered by the leg attachment section when the leg sections are attached to the connection member.
